(19) United States
(12) Patent Application Publication
(10) Pub. No.: US 2001/0054658 A1
(43) Pub. Date: Dec. 27, 2001

(54) Roughly fragmenting blade and crushing device

(76) Inventor: Shoji Nakagomi, Urawa-shi (JP)

Correspondence Address: Eric B. Meyertons, CONLEY, ROSE & TAYON, P.C., P.O. Box 398, Austin, TX, 78767-0398, US

(21) Appl. No.: 09/881,392

(22) Filed: Jun. 13, 2001

(30) Foreign Application Priority Data
Jun. 15, 2000 (JP) 2000-180487

(51) Int. Cl. B02C 18/16

(52) U.S. Cl. 241/236; 241/295

(57) ABSTRACT

To avoid reduction in efficiency of rough fragmentation operation with a rough fragmenting blade by making it difficult for fragments to stay in clearances between rough fragmenting blades of roughly fragmenting blade rotary structures so that rotation of the roughly fragmenting blade rotary structures is kept to the initial drive state. A roughly fragmenting blade (2) has a recessed portion (27) in a side surface of a roughly fragmenting blade main body having an outer peripheral edge formed with a blade portion (22). This recessed portion is formed in an annular manner in an intermediate region that is on the inner side in the radial direction with respect to the blade portion and is outside a bearing region. The recessed portion is for facilitating removal of cut fragments, i.e., for securing a clearance wider than the width of a cutting portion formed by the blade portions of the opposing roughly fragmenting blades when the roughly fragmenting blades are mounted to a roughly fragmenting blade rotary structure. The recessed portion is formed in one side surface or both side surfaces of the roughly fragmenting blade main body, depending on the construction and installment location of the roughly fragmenting blade rotary structure.

### BACKGROUND OF THE INVENTION

1. Field of the Invention

The present invention relates to the construction of a roughly fragmenting blade used for roughly fragmenting a scrap material, typically, a synthetic resin product, and to a crushing device having the roughly fragmenting blade installed therein.

2. Description of the Related Art

A crushing device used for recycle of scrap materials of synthetic resin products, or used in pretreatment for disposal, has, as shown in FIG. 10, a pair of roughly fragmenting blade rotary structures A and A′, which are installed inside the device. As shown in FIG. 9, the roughly fragmenting blade rotary structure A is generally constructed such that a large number of roughly fragmenting blades C are mounted to a shaft portion B with a clearance D corresponding to the thickness of the blade and in a state where the phases are shifted. The roughly fragmenting blade rotary structures A and A′ are supported at a position defined such that the roughly fragmenting blades C of the roughly fragmenting blade rotary structure A are inserted into a clearance D′ between adjacent roughly fragmenting blades of the other roughly fragmenting blade rotary structure A′, and these structures A and A′ receive drive force to rotate inward relative to each other.

The roughly fragmenting blade C has a plurality of protruded blades E in the form of claw, which are protrudingly arranged on the outer peripheral surface with intervals in the circumferential direction. A blade portion is formed on an outer peripheral edge portion including these protruded blades E and the outer peripheral surface. The blade portions of the roughly fragmenting blades C′ of the other roughly fragmenting blade rotary structure A′ are inserted into the clearances D between the roughly fragmenting blades of the roughly fragmenting blade rotary structure A so that the blade portions of both the roughly fragmenting blades C and C′ cut the scrap material of the synthetic resin product into fragments the width of which is substantially the same as the clearance portion D. The fragments thus cut fall downward.

The scrap material is an elastic material. Therefore, although depending on its size and form, the scrap material is slightly deformed in the width direction of the blades and crushed by being nipped by the protruded blades E and E′ in the cutting. As a result, a fragment F is released from this deforming pressure after the cutting by the protruded blade E so that the ends of the fragment are elastically restored within the clearance between the roughly fragmenting blades of the other roughly fragmenting blade rotary structure A′. Thus the fragment is stuck at the clearance. The fragment F stuck at the clearance rotates along with the roughly fragmenting blade rotary structures.

The fragment F staying in the clearance usually falls down when scraped off the clearance by scrapers G and G′ that are disposed external to the roughly fragmenting blade rotary structures A and A′. However, a fitted fragment that is tightly fitted to the clearance by its elasticity as in the above won't be scraped off the clearance when it comes into contact with the scrapers G and G′, and stays in the clearance while sliding in the circumferential direction of the rotary structures below the scrapers. Fragments staying in the clearances gradually increase their volume as the operation of the crushing device is prolonged, filling up the space below the scrapers (See FIG. 10). This is a great load for rotation of the roughly fragmenting blade rotary structures A and A′ and eventually causes the roughly fragmenting blade rotary structures A and A′ to stop their rotation. The staying fragments also make it difficult to open a door provided to clean the scrapers G and G′ and the roughly fragmenting blade rotary structures A and A′.

### SUMMARY OF THE INVENTION

An object of the present invention is to provide a roughly fragmenting blade and a crushing device using the same, in which fragments hardly stay in clearances between roughly fragmenting blades of roughly fragmenting blade rotary structures, thereby keeping rotation of the roughly fragmenting blade rotary structures to the initial drive state and preventing reduction in efficiency of rough fragmentation operation with roughly fragmenting blades.

To achieve the above-noted object, the present invention has the following construction.

A roughly fragmenting blade according to the present invention has a recessed portion in a side surface of a roughly fragmenting blade main body having an outer peripheral edge formed with a blade portion. This recessed portion is formed in an annular manner in an intermediate region that is on the inner side in the radial direction with respect to the blade portion and is outside a bearing region. The recessed portion is for facilitating removal of cut fragments, i.e., for securing a clearance wider than the width of a cutting portion formed by the blade portions of the opposing roughly fragmenting blades when the roughly fragmenting blades are mounted to a roughly fragmenting blade rotary structure.

The recessed portion is formed in one side surface or both side surfaces of the roughly fragmenting blade main body, depending on the construction and installment location of the roughly fragmenting blade rotary structure.

The recessed portion is formed in the intermediate region along the circumferential direction thereof as an annulus or as a discontinuous annulus (a group of recesses arranged intermittently). If the discontinuous annulus is employed, non-recessed portions in this annulus have to have a size that makes it difficult for fragments to stay therein. The depth of the recessed portion is appropriately set taking into consideration the strength of the roughly fragmenting blade and the like.

In a crushing device according to the present invention, a roughly fragmenting blade rotary structure is comprised of a plurality of roughly fragmenting blades described above, the roughly fragmenting blades being mounted to a rotary shaft with clearances corresponding to the width of the roughly fragmenting blades; and the roughly fragmenting blade rotary structure is provided in a pair, so that the pair of roughly fragmenting blade rotary structures are supported to be rotatable inward relative to each other in a state where some blade portions of the roughly fragmenting blades of one roughly fragmenting blade rotary structure enter the clearances between the roughly fragmenting blades of the other roughly fragmenting blade rotary structure. If the fragments obtained through the rough fragmentation are to be further fragmented, a finely fragmenting blade rotary structure is rotatably supported below the pair of roughly fragmenting blade rotary structures.

### BRIEF DESCRIPTION OF THE DRAWINGS

In the accompanying drawings:

FIG. 1 is a side sectional view showing main portions of a crushing device according to an embodiment of the present invention;

FIG. 2 is a side view of a roughly fragmenting blade used in the device shown in FIG. 1;

FIG. 3 is a frontal sectional view of the roughly fragmenting blade used in the device shown in FIG. 1;

FIG. 4 is a side view showing the appearance of the device of FIG. 1;

FIG. 5 is a frontal view showing the appearance of the device of FIG. 1;

FIG. 6 is a plane view showing an engagement state of the roughly fragmenting blades of roughly fragmenting blade rotary structures;

FIG. 7 is a plane view of a finely fragmenting blade rotary structure and a stationary blade;

FIG. 8 is a side view of the finely fragmenting blade rotary structure shown in FIG. 7;

FIG. 9 is a perspective view showing a conventional roughly fragmenting blade; and

FIG. 10 is an explanatory diagram illustrating problems found in the conventional roughly fragmenting blade and in a conventional crushing device.

### DETAILED DESCRIPTION OF THE PREFERRED EMBODIMENT

The present invention will be described based on an illustrated embodiment.

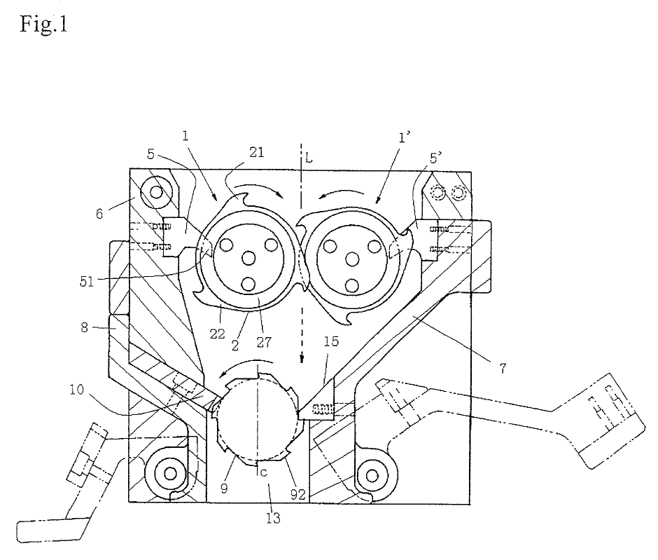

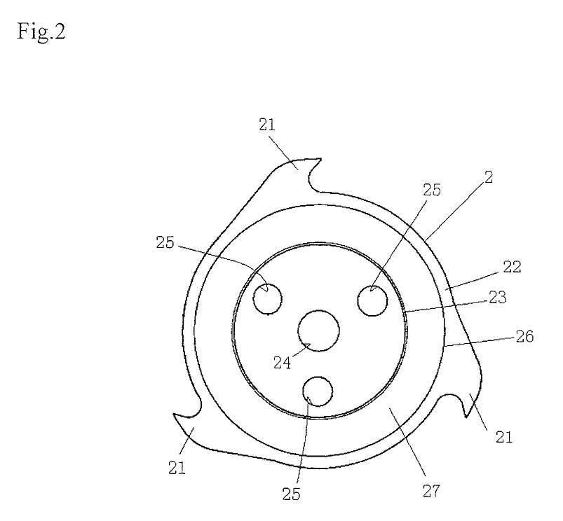

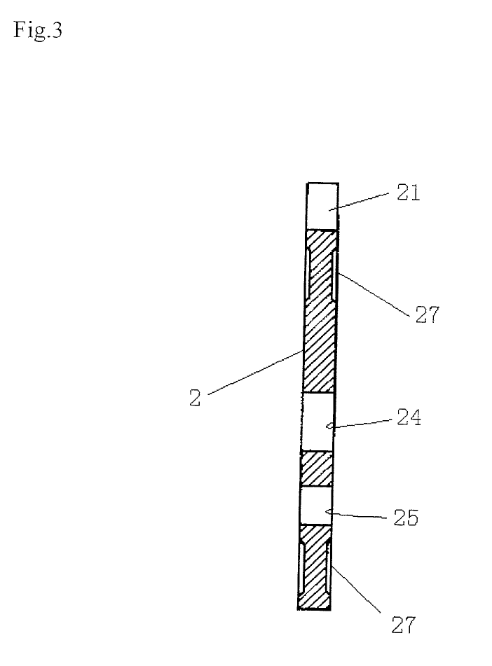

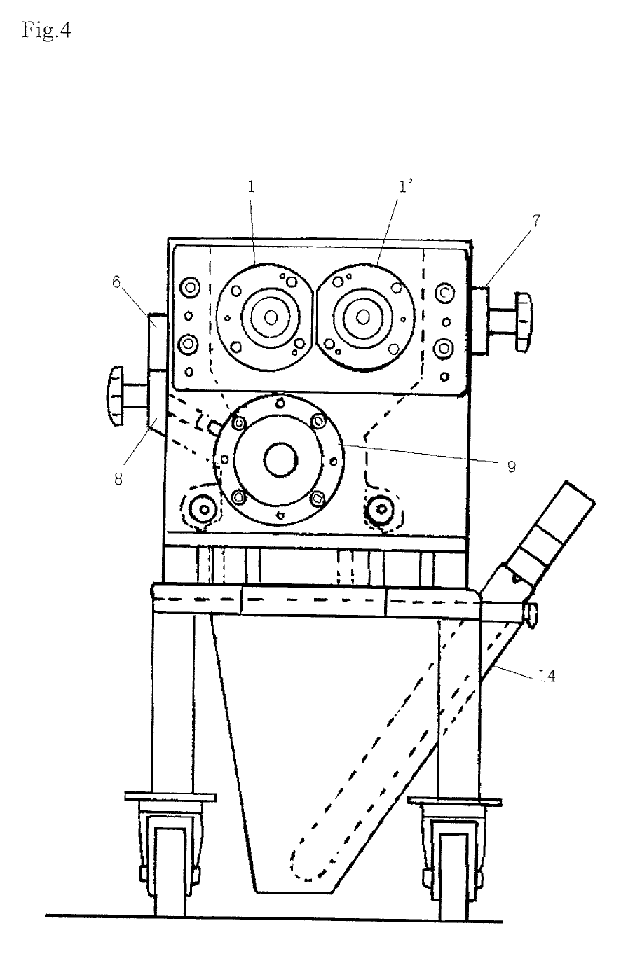

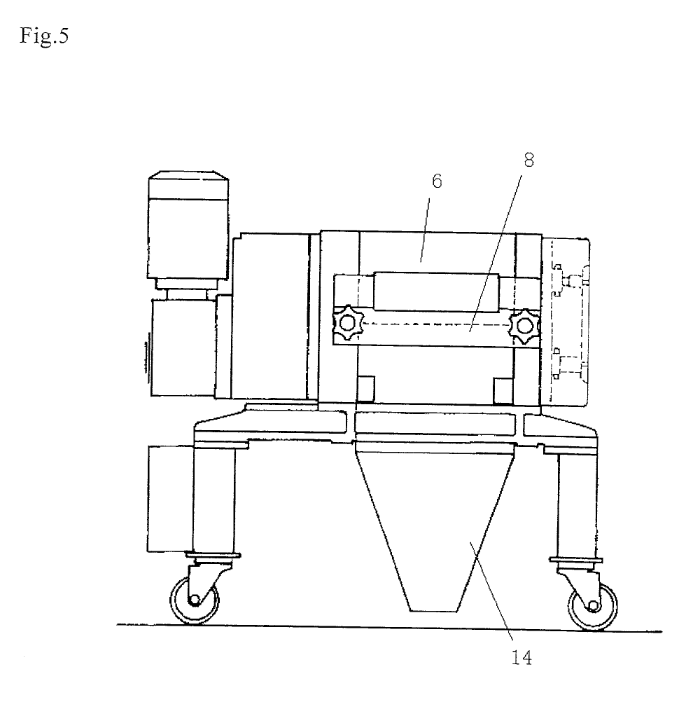

FIG. 1 is a side sectional view showing main portions of a crushing device for synthetic resin made scrap material according to an embodiment of the present invention. FIG. 2 is a side view of a roughly fragmenting blade used in the device. FIG. 3 is a sectional view of the roughly fragmenting blade viewed from the front. FIG. 4 is a side view showing the appearance of the device. FIG. 5 is a frontal view showing the appearance of the device.

In the drawings, the reference numerals 1 and 1′ denote a pair of roughly fragmenting blade rotary structures which are rotatably supported in an upper space within a device main body casing, and which have the same construction. The roughly fragmenting blade rotary structure 1 on the left hand side of the drawing will be described. Components of the roughly fragmenting blade rotary structure 1′ on the right hand side are denoted in the drawings or in the following description by reference numerals obtained by adding dash (′) to the reference numerals denoting corresponding components of the roughly fragmenting blade rotary structure 1 on the left hand side, for the purpose of avoiding repeated description.

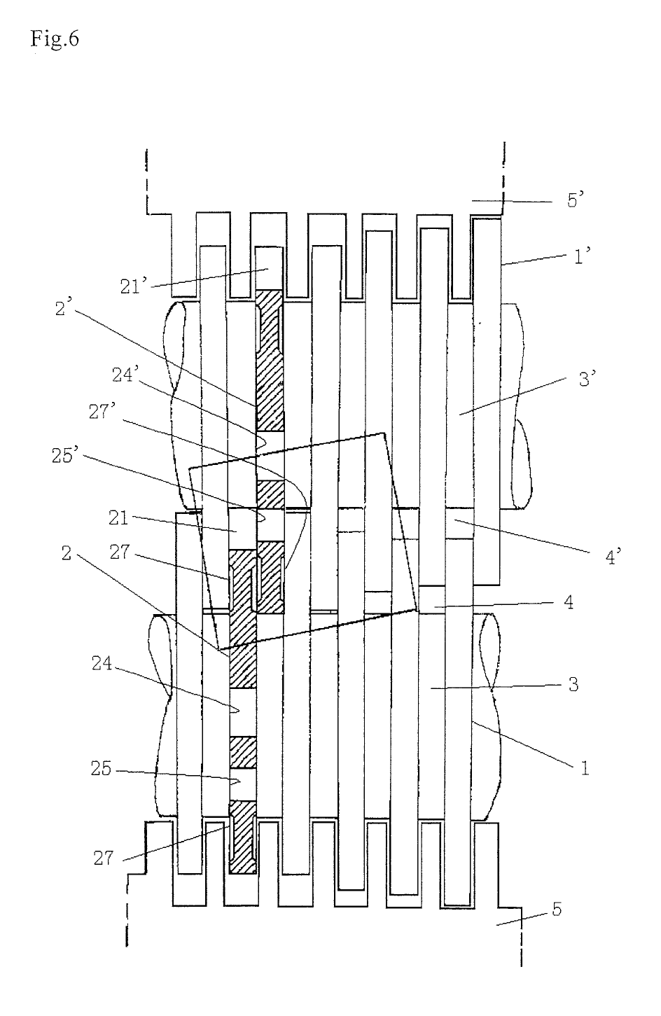

The roughly fragmenting blade rotary structure 1 includes a large number of roughly fragmenting blades 1, an annular connection members (spacers) 3 (see FIG. 6) for connecting the roughly fragmenting blades 2 with predetermined clearances, and a connection bolt (not shown) piercing through the roughly fragmenting blades 2 and the annular connection members 3 to connect and fix these members together.

As can be seen in FIGS. 2 and 3, each of the roughly fragmenting blades 2 is provided with three protruded blades 21 in the form of claws, which are protrudingly arranged on an outer peripheral surface with circumferential intervals of 120 degrees. A blade portion 22 is formed on an outer peripheral edge portion including these protruded blades 21 and the remaining outer peripheral surface.

Reference numeral 23 denotes a bearing portion region provided in a side surface of the roughly fragmenting blade 2, which is formed at its center with an insertion hole 24 for the connection bolt, and at concentric positions apart from the center by a predetermined distance with three pin holes 25. An end face of the annular connection member 3 interposed between the adjacent roughly fragmenting blades is brought into contact with and fixed to the bearing portion region 23. The annular connection member 3 is smaller in diameter than the roughly fragmenting blade 2 and has a width the same as a thickness width of the roughly fragmenting blade 2. Similar to the roughly fragmenting blades 2, the annular connection member 3 has an insertion hole for the connection bolt at its center, and three pin holes around the insertion hole. By inserting pins and the connection bolts into the pin holes and the insertion holes, respectively, and tightening the bolt end portion with a nut, the roughly fragmenting blades 2 and the annular connection members 3 are united to construct the roughly fragmenting blade rotary structure 1. An outer portion of the peripheral surface of the annular connection member 3 which is partitioned by the adjacent two roughly fragmenting blades 2 forms a clearance portion 4 into which a roughly fragmenting blade 2 of the other roughly fragmenting blade rotary structure 1′ can be inserted. A large number of roughly fragmenting blades 2 are mounted such that the phases of the protruded blades 21 are shifted gradually.

An intermediate portion region 26 is defined between the bearing portion region 23 of the roughly fragmenting blade side surface and the above-mentioned blade portion 22. The intermediate portion region 23 is formed with an annular recessed portion 27. The recessed portion 27 extends from a boundary between the intermediate portion region 26 and the bearing portion region 23 to a boundary between the intermediate portion region 26 and the blade portion region 22, and occupies substantially the entire intermediate portion region 26. The recessed portion 27 is provided in each of the side surfaces of the roughly fragmenting blade 2, and has such an appropriate depth that does not affect adversely the strength of the roughly fragmenting blade 2.

The roughly fragmenting blade rotary structures 1 and 1′ are rotatably supported such that rotational axes thereof are parallel to each other, and the projected blades 21 of the roughly fragmenting blades 2 are symmetrical. The roughly fragmenting blade rotary structures 1 and 1′ are rotated inward relatively to each other while the blade portion 22 including the protruded blades 21 of the roughly fragmenting blade 2 of the roughly fragmenting blade rotary structure 1 enters a clearance portion 4′ between the roughly fragmenting blades of the other roughly fragmenting blade rotary structure 1′ so that the blade portions of the roughly fragmenting blades can be slidingly contacted (see FIG. 6).

Reference numerals 5 and 5′ in the drawings respectively denote left and right scrapers that are disposed outside of the roughly fragmenting blade rotary structures 1 and 1′, and that are positioned such that a leading end scraping claw 52 enters the clearance between the roughly fragmenting blades of the roughly fragmenting blade rotary structure 1. During the rotation of the roughly fragmenting blade rotary structure 1, the scraper scrapes fragments remaining in the clearance. One scraper 5 on the left hand side of the drawing is fixed to an inner wall surface upper portion of a left upper rotatable door 6 having its upper portion hinge-connected to the device main body casing. The other scraper 5′ on the right hand side of the drawing is fixed to an inner wall surface upper portion of a right rotatable door 7 having its lower portion hinge-connected to the casing. The open position of the right rotatable door 7 is shown by dotted line in FIG. 1. Provided below the left upper rotatable door 6 is a left lower rotatable door 8 having its lower portion hinge-connected to the casing.

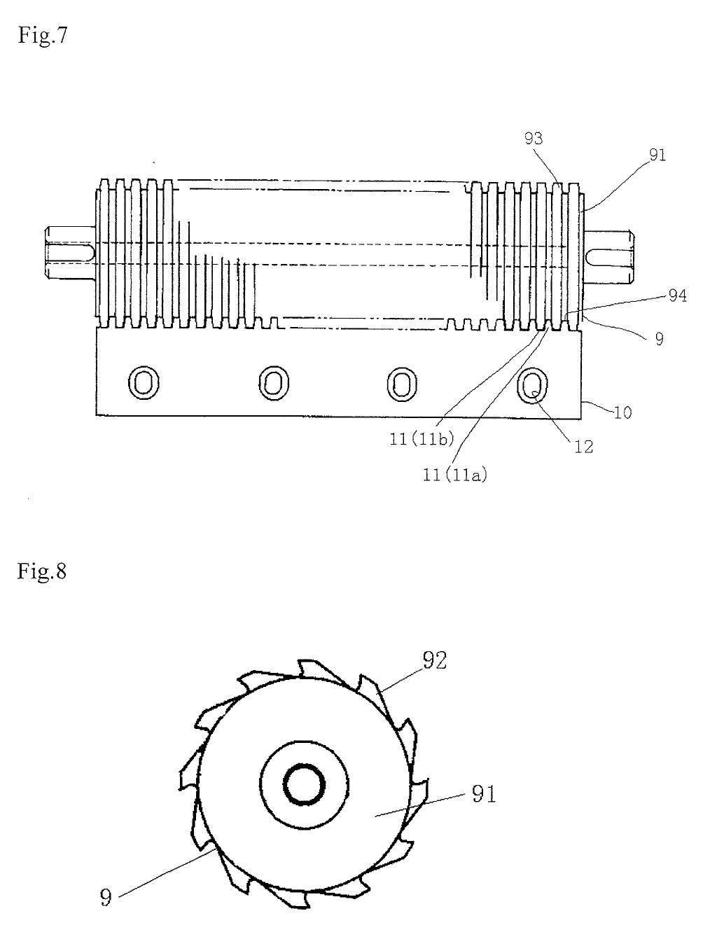

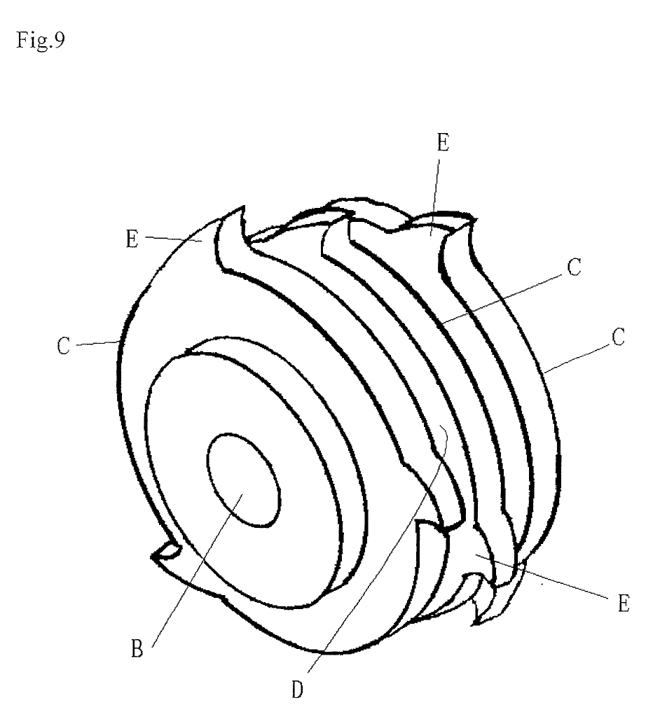

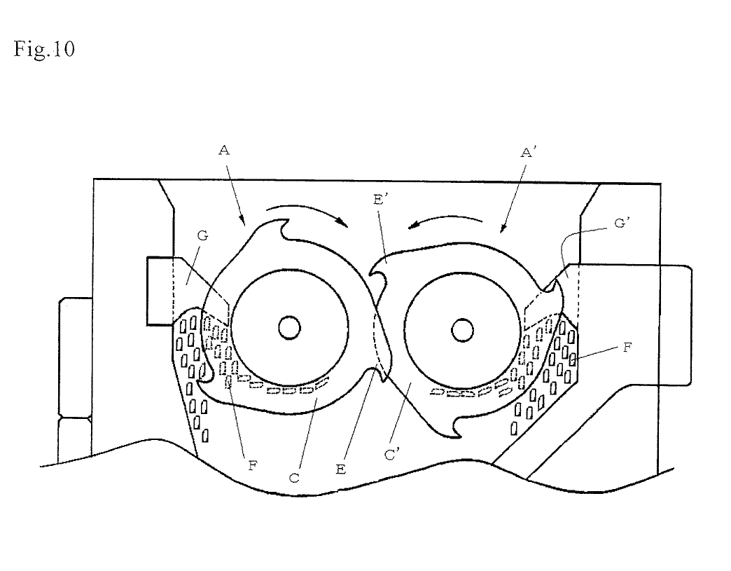

A single finely fragmenting blade rotary structure 9 is rotatably supported in a space below the pair of the roughly fragmenting blade rotary structures 1 and 1′. As shown in FIGS. 7 and 8, the finely fragmenting blade rotary structure 9 is constructed such that a large number of finely fragmenting blades 92 are protruded around the surface of a cylindrical barrel portion 91, and the large number of annular protruded blades 93 are juxtaposed with predetermined clearances. As shown in FIG. 7, the blade tip of the finely fragmenting blade 92 is in the form of a trapezoid in a plane view. The finely fragmenting blade rotary structure 9 is supported at a position defined such that a central normal line C thereof is offset in the leftward direction in FIG. 1 from a central normal line L at a position where the blade portions 22 of the roughly fragmenting blade rotary structures 1 and 1′ in the space above are engaged with each other to conduct the rough fragmentation (See FIG. 1).

The left front portion of the finely fragmenting blade rotary structure 9 is confronted with and close to the inner wall surface lower portion of the above-mentioned left lower rotatable door 8. A stationary blade 10 is mounted to this inner wall surface lower portion of the left lower rotatable door 8. The stationary blade 10 has a comb-like, concave and convex blade 11 formed from a plate material and arranged at a leading end of a stationary blade main body (see FIG. 7). Convex blade 11a is substantially in the form of a trapezoid in a plane view similar to the finely fragmenting blade 92, and enters the clearance 94 between the finely fragmenting blades of the finely fragmenting blade rotary structure 9. On the other hand, the finely fragmenting blade 92 enters between the convex blades so as to be confronted with the concave blade 11b.

Reference numeral 12 denotes an oblong hole formed in the stationary blade main body for fastening a bolt. By changing the position at which the bolt is fastened within a range of the length of the oblong hole, the clearance in the back and forth direction between the finely fragmenting blade 92 of the finely fragmenting blade rotary structure 9 and the concave and convex blade 11 of the stationary blade 10 can be adjusted.

The finely fragmenting blade rotary structure 9 is rotated in the direction toward the stationary blade 10.

The right and rear portion of the finely fragmenting blade rotary structure 9 in the drawing is confronted with and close to the inner wall surface lower portion of the aforementioned right rotatable door 7. A scraper 15 for finely fragmenting blade is attached to this inner wall surface lower portion of the right rotatable door 7. The scraper 15 for fine fragmentation scrapes small pieces of crushed material remaining in the clearances between the finely fragmenting blades by inserting its leading end comb-like scraping claws into the clearances.

In FIG. 1, reference numeral 13 designates a discharge port provided below the finely fragmenting blade rotary structure 9. In FIGS. 4 and 5, reference numeral 14 denotes a container for crushed material, which is disposed below the discharge port 13.

The operation of the device will be described.

The scrap material put into the device through a not-shown throw-in port disposed at an upper portion of the device in FIG. 1 or in FIGS. 4 and 5, falls onto the upper surfaces of the roughly fragmenting blade rotary structures 1 and 1′. The pair of roughly fragmenting blade rotary structures 1 and 1′ move the scrap material in the direction toward the central normal line L of the roughly fragmenting blade rotary structures, and cut the scrap material into fragments with the blade portions 22 of the roughly fragmenting blades 2 while pulling the scrap material inside with protruded blades 21 of the roughly fragmenting blades 2. Each of the fragments thus obtained is in the form of a strip having the width thickness of the roughly fragmenting blade 2. During the cutting, the fragment in the form of strip is slightly deformed in the width direction while being roughly fragmented, and immediately after the cutting, the ends of the fragment are elastically restored within the clearance portion into which the protruded blade 21 enters, so as to be enlarged beyond the dimension of the clearance between the blade portions. However, since the roughly fragmenting blade 2 has the recessed portion 27 in the intermediate portion region 26 that is nearer to the center than the blade portion 22 in the radial direction, and the clearance between the roughly fragmenting blades is wider by an amount corresponding to the sum of depths of the recessed portions than the clearance between the blade portions (see FIG. 6), the enlargement of the fragment is cancelled out by the recessed portions and thus the fragment falls without being clogged in the clearance.

Hence, fragment pieces are not accumulated below the scrapers, and the rough fragmenting blade rotary structures 1 and 1′ maintain the initial operating rotation speed and the initial torque.

The recessed portion 27 formed in each side surface of the rough fragmenting blade 2 need not be a continuous annulus, but plural recessed portions may be arranged intermittently in an annular manner. If required, the recessed portion 27 may be formed only in one side surface of the rough fragmenting blade 2. In this case, the roughly fragmenting blades are assembled such that the recessed portion is disposed at either one of the opposing side surfaces of adjacent roughly fragmenting blades.

The fragments that have fallen under the roughly fragmenting blade rotary structures 1 and 1′ are received by the upper surface of the finely fragmenting blade rotary structure 9. At this time, since the central normal line C of the finely fragmenting blade rotary structure 9 is offset in the direction toward the stationary blade 10 relative to the central normal line L passing through the cutting portion of the roughly fragmenting blade rotary structures 1 and 1′, the fragments are received by an upper surface position of the finely fragmenting blade rotary structure 9, which is offset in the rightward direction from the central normal line C. Accordingly, a large area can be used as a receiving space, extending from the upper surface position to a position where the finely fragmenting blade rotary structure 9 performs the fine fragmentation in cooperation with the stationary blade 10.

The fragments moved to the crushing portion of the finely fragmenting blade rotary structure 9 and the stationary blade by rotation of the annular protruded blades 93 of the finely fragmenting blade rotary structure 9 are finely fragmented or crushed by the trapezoidal concave and convex blade 11 of the stationary blade 10 and the finely fragmenting blades 92 of the finely fragmenting blade rotary structure 9, and falls down from the discharge port 13 to be accommodated within the container 14.

The degree of crushing is set such that the stationary blade 10 is moved forward or backward along the oblong holes 12 to adjust the clearance between the concave and convex blade 11 and the finely fragmenting blade 92 widely or narrowly. The required work for this clearance adjustment, such as confirmation using a clearance gage, and tightening of a fixing piece with bolts, can be conducted relatively easily since the central normal line C of the finely fragmenting blade rotary structure 9 is offset in the leftward direction in the drawing from the central normal line L of the roughly fragmenting blade rotary structures 1 and 1′, and the stationary blade 10 is located at a position close to the near side of the operator with respect to the central portion of the device main body. When the central normal line C of the finely fragmenting blade rotary structure coincides with the central normal line L of the roughly fragmenting blade rotary structures 1 and 1′, the stationary blade 10 has to be located in the center of the device main body to make it difficult to conduct clearance adjustment work.

Since the concave and convex blades 11 and the finely fragmenting blades relating to the crushing are each in a substantially trapezoidal shape in a plane view, the proximal end has an obtuse angle and, further, the distal end is wider than the proximal end. Therefore, the blade is hardly chipped and easy to handle in a case where the blade is worn out, in contrast to a conventional one having a rectangular shape in a plane view. Also, there is an advantage in that the aforementioned work for clearance adjustment can be conducted relatively easily.

The aforementioned pair of roughly fragmenting blade structures 1 and 1′ cut the scrap material into fragments by slidingly contacting the blade portions 22 provided in the peripheral edge portions of the opposing roughly fragmenting blades 2 with one another. Therefore, the fragments are inevitably formed as strips having a width substantially corresponding to the widths of the roughly fragmenting blades 2 to be relatively large pieces. However, the final crushed material is required to have particle quality comparable to virgin pellet in order to put the crushed material as it is into a synthetic resin molding machine. For this reason, the device of the embodiment described above is provided with the finely fragmenting blade rotary structure 9 disposed below the roughly fragmenting blade rotary structures 1 and 1′ thereby finely fragmenting the fragments. In order to make sure that the finely fragmented fragments have a particle quality close to that of the virgin pellet, the fragments obtained by the anterior roughly fragmenting process must be not so large. According to the inventor's knowledge, the width of the roughly fragmenting blade 2 is preferably set to be 1.7 times or less of the apex-to-bottom dimension of the finely fragmenting blade, taking into account the processing efficiency.

When the maintenance is required, the right rotatable door 7 is opened downward, so that the rear portion of the roughly fragmenting blade rotary structure 1′ on the right hand side and the scraper 5 for the roughly fragmenting blade and the scraper 15 for fine fragmentation on the right hand side are exposed. When the left hand side lower rotatable door 8 is opened downward, the front portion of the finely fragmenting blade rotary structure 9 and the stationary blade 10 are exposed. When the left hand side upper rotatable door 6 is opened upward, the roughly fragmenting blade rotary structure on the left hand side and the scraper for roughly fragmenting blades in the left hand side are exposed. Since there is almost no case that the fragments clog the spaces below the scrapers and are accumulated therein, the right rotatable door 7 and the left upper rotatable door 6 are opened smoothly. Further, cleaning, replacement of parts, checking operation are conducted very easily.

The crushing device using the roughly fragmenting blades according to the present invention does not necessarily have both the rough fragmenting blade rotary structures provided in its upper part and the finely fragmenting blade rotary structure arranged in its lower part as in the aforementioned embodiment. Instead the crushing device may have only the roughly fragmenting blade rotary structure for the single purpose of rough fragmentation. The roughly fragmenting blade itself is applicable also to the case where the roughly fragmenting blade and the finely fragmenting blade are mounted to a single rotary body.

Moreover, the roughly fragmenting blade according to the present invention can also be used in crushing devices for various kinds of materials in addition to the crushing devices for synthetic resin products.

According to the present invention, the roughly fragmenting blade has, in the intermediate region in the side surface thereof, the annular recessed portion for facilitating the removal of cut fragments. It is thus possible to prevent the fragments from being elastically fitted to the clearances between the roughly fragmenting blades, making it difficult for the fragments to stay in the clearances. Therefore the rotation of the roughly fragmenting blade rotary structure can be kept to an appropriate state all the time, whereby reduction in efficiency of rough fragmentation operation can be avoided.

What is claimed is:

1. A roughly fragmenting blade, wherein a recessed portion for facilitating removal of cut fragments is formed in an annular manner in a side surface of a roughly fragmenting blade main body having an outer peripheral edge formed with a blade portion and in an intermediate region that is on the inner side in the radial direction with respect to the blade portion and is outside a bearing region.

2. The roughly fragmenting blade according to claim 1, wherein the recessed portion is formed in each side surface of the roughly fragmenting blade main body.

3. The roughly fragmenting blade according to claim 1, wherein the recessed portion is formed almost all over the intermediate region that is a continuation of the blade portion.

4. The roughly fragmenting blade according to claim 1, wherein the recessed portion is a group of recesses arranged intermittently in a side surface of the roughly fragmenting blade main body along the circumferential direction thereof, so that the recesses together form an annulus.

5. A crushing device wherein:
a roughly fragmenting blade rotary structure is comprised of a plurality of roughly fragmenting blades as claimed in claim 1, the roughly fragmenting blades being mounted to a rotary shaft with clearances corresponding to the width of the roughly fragmenting blades; and
the roughly fragmenting blade rotary structure is provided in a pair, so that the pair of roughly fragmenting blade rotary structures are supported to be rotatable inward relative to each other in a state where some blade portions of the roughly fragmenting blades of one roughly fragmenting blade rotary structure enter the clearances between the roughly fragmenting blades of the other roughly fragmenting blade rotary structure.

6. The crushing device according to claim 6, wherein a finely fragmenting blade rotary structure is rotatably supported below the pair of roughly fragmenting blade rotary structures.
